(19) United States
(12) Patent Application Publication
(10) Pub. No.: US 2009/0287709 A1
(43) Pub. Date: Nov. 19, 2009

(54) INFORMATION PROCESSING APPARATUS FOR EDITING DOCUMENT HAVING ACCESS RIGHT SETTINGS, METHOD OF INFORMATION PROCESSING, AND PROGRAM

(75) Inventor: Yuki Kusakabe, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/466,231

(22) Filed: May 14, 2009

(30) Foreign Application Priority Data
May 16, 2008 (JP) 2008-129581

(51) Int. Cl. G06F 12/14; G06F 17/30

(52) U.S. Cl. 707/9; 707/102; 707/E17.005

(57) ABSTRACT

An information processing apparatus according to the invention manages a plurality of documents, each including a plurality of pages and being provided with an access right. The information processing apparatus includes a storing unit configured to store the plurality of documents as one file on the basis of the access rights and information of a user who performs processing on the documents; a creating unit configured to create a page list that describes page information, which is information regarding each page stored by the storing unit; and an outputting unit configured to output a page included in the file on the basis of the page list created by the creating unit.

### BACKGROUND OF THE INVENTION

1. Field of the Invention

The present invention relates to a method of editing a document that has access right settings.

2. Description of the Related Art

Recently, an access right managing server has been developed that sets access rights (viewing, editing, printing, etc.) for a document to prevent the leakage of information of the document.

This server can also set an expiration date for the document. After the set expiration date, whatever access rights have been set become invalid.

One of the known access right managing servers for documents is a policy server (LiveCycle ES Rights Management) produced by Adobe Systems Incorporated (simply called Adobe hereinafter).

This policy server allows the above-mentioned access rights and expiration date to be set, by issuing a policy to be applied to a Portable Document Format (PDF) file, which is a type of document.

On the other hand, secondary processing of a document is common in which a new document is produced by merging an existing document with other documents or images.

In such a case where a document is processed for the purpose of secondary processing, a document having access right settings should be able to be subjected to secondary processing while the policy is kept as is, so as to effectively utilize the merit of the access rights.

A similar technology has been disclosed in, for example, Japanese Patent Laid-Open No. 2004-259195, as follows: When access rights have been set for a portion of a document, a confidential portion without access rights is removed and only portions with access rights are collected and displayed as an electronic document. Further, when the deleted confidential portion includes a paragraph number, new paragraph numbers in a sequence are reassigned to the document.

Another example of merging a plurality of documents having access right settings is a technology called a packaged PDF provided by Adobe in which different PDF flies are merged into one PDF file. This technology has restriction in which merging is performed on a PDF file-by-PDF file basis.

However, the technology described in Japanese Patent Laid-Open No. 2004-259195 does not allow a confidential portion to be removed unless the control unit of a client computer first reads all documents to recognize the access rights and makes reference to all the documents to be processed.

Generally, persons who can change the rights which have been set in advance for documents are the users that set the access rights for each of the documents.

When a plurality of documents having access right settings are merged into one document, the following problem arises.

When a user who is checking the content of a document is different from the user who set the access rights, the user who is checking the document having access right settings cannot set new access rights.

Therefore, it is difficult for a user who is checking a document having access right settings to freely perform processing on a document produced by merging a plurality of documents even when the user has the access rights.

For instance, the following processing cannot be performed.

Assume that there are documents A and B each having different access right settings.

The document A consists of a total of 5 pages and the document B consists of a total of 8 pages.

When only pages 1 to 3 (a portion) of the document A and pages 6 to 8 of the document B are extracted, each accompanied by respective access rights, and merged into a new document, this new document cannot be edited.

### SUMMARY OF THE INVENTION

The present invention addresses the above problems and makes it possible to merge a plurality of documents having access right settings without changing respective policies applied to the documents.

The present invention provides an information processing apparatus that manages a plurality of documents, each including a plurality of pages and being provided with an access right. The information processing apparatus includes a storing unit configured to store the plurality of documents as one file on the basis of the access rights and information of a user who performs processing on the documents; a creating unit configured to create a page list that describes page information, which is information regarding each page stored by the storing unit; and an outputting unit configured to output a page imported into the file on the basis of the page list created by the creating unit.

The present invention makes it possible to merge a plurality of documents having access right settings without changing respective policies applied to the documents.

Hence, this will increase user convenience.

Further features of the present invention will become apparent from the following description of exemplary embodiments with reference to the attached drawings.

### BRIEF DESCRIPTION OF THE DRAWINGS

FIG. 1 is a general view of a configuration according to an embodiment of the present invention.

FIG. 2 is a flowchart showing the process of issuing an online policy.

FIG. 3 is a flowchart showing the process of applying the online policy to a document.

FIG. 4 is a flowchart showing the process of accessing a document.

FIG. 5 is a flowchart showing the authentication process of the online policy.

FIG. 6 is a flowchart showing the process of importing a plurality of documents.

FIG. 7 is a flowchart showing the process of storing the imported documents.

FIG. 8 is a conceptual view of a virtual document.

FIG. 9 is a flowchart showing the process of obtaining page information from the imported documents and creating a list.

FIG. 10 is a conceptual view of the list, which describes page information.

FIG. 11 is a flowchart showing the process of rearranging the pages of the imported documents.

FIG. 12 is a conceptual view of the state of a list during previewing and the state of display at this time.

FIG. 13 is a flowchart showing the process of copying and deleting pages in a virtual document.

FIG. 14 is a conceptual view of the state of a list when pages are copied or deleted.

FIG. 15 is a flowchart showing the process of printing a virtual document.

FIG. 16 is a diagram showing an example layout change.

FIG. 17 is a flowchart showing the process of opening a document in accordance with the access rights and importing the document.

### DESCRIPTION OF THE EMBODIMENTS

### First Embodiment

The terms used in the present embodiment are defined below.

### (1) Accessing

“Accessing a document” includes the following three things:
A client computer displays a document in accordance with a display instruction from a user.
A client computer edits a document in accordance with an edit instruction from a user.
A client computer sends a print command to a printer in accordance with a print instruction from a user.
The display instruction, edit instruction, and print instruction are called access instructions.

### (2) Access Rights

An “access right for a document” is a right for allowing a client computer to perform processing (processing on the document) in accordance with an access instruction. When a client computer is in a state where it is allowed to perform processing (processing on a document) in accordance with an access instruction from a specific or any user, the user is said to have an access right for the document. When a client computer is in a state where it is not allowed to perform processing (processing on a document) in accordance with an access instruction from a specific or any user, the user is said not to have an access right for the document. Access rights include a viewing right, an editing right, and a printing right.

### (3) Setting Access Rights

“Setting access rights” conceptually means giving a specific or any user access rights for a specific document. In an actual operation, it means that a file is created and stored that associates the access rights with user information (information specifying a specific user or any user) and the file is applied to the specific document.

### (4) Policy

A “policy” means the above-described file that shows the association. Hence, “creating and storing a policy” and “applying the policy to a document” together mean “setting access rights for the document”.

### (5) Policy Server

A “policy server” means a server apparatus that creates and stores a policy. “Creating and storing a policy for a certain document” and “Issuing a policy (for a certain document)” have the same meaning.

### (6) Page Information

“Page information” means the number of pages and the sequence of pages of a document.

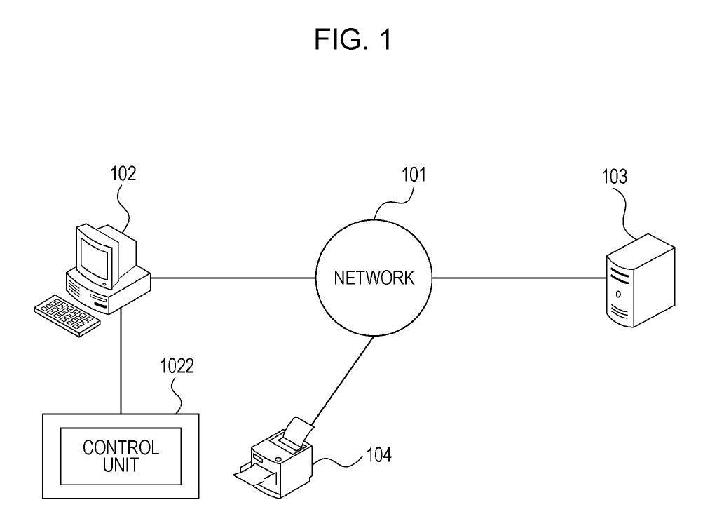

FIG. 1 shows a network 101, a client computer 102 functioning as an information processing apparatus, a policy server 103, and a printer 104. The network 101 functions as a communication link for sending and receiving information among the above apparatuses. For instance, the network 101 may be any wired or wireless network supporting the TCP/IP protocol or the like.

The client computer 102 includes a control unit 1022.

The control unit 1022 performs well known general functions of a client computer. For example, the control unit 1022 includes software installed thereon such as Acrobat and Acrobat Reader (registered trademarks) available from Adobe, among others. In addition, the control unit 1022 can execute portions of the processing of flowcharts disclosed in the present embodiment or later.

The printer 104 performs well known general functions of a printer. For example, when the printer 104 receives a print request from the control unit 1022 of the client computer 102, it performs printing in accordance with the print request.

### Issuing a Policy for Online Environment Use (Online Policy)

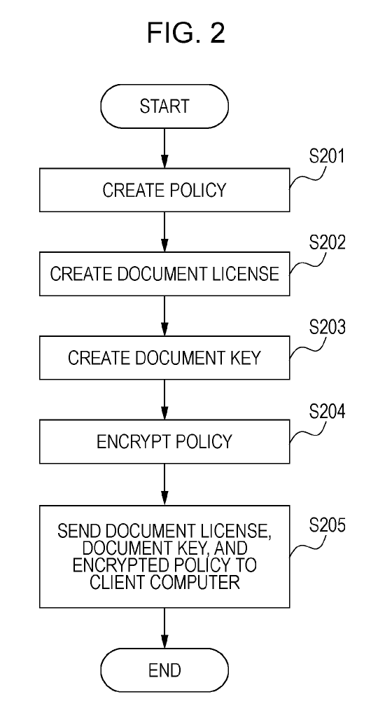

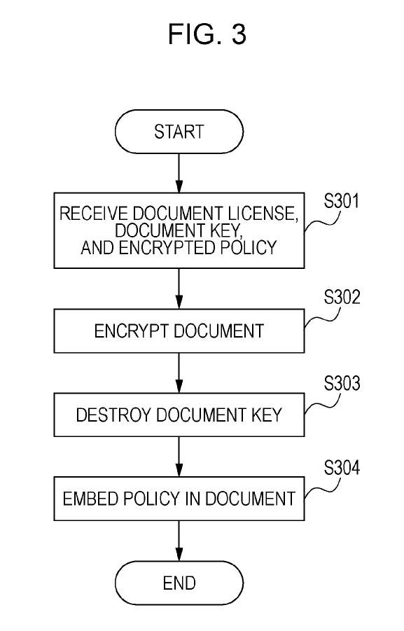

FIG. 2 shows a flowchart for issuing an online policy performed by the policy server 103, and FIG. 3 shows a flowchart for applying the online policy to a document (for example, a PDF file) performed by the client computer 102.

The client computer 102, having received a create-online-policy instruction, sends accordingly a notification to the policy server 103.

Note that the create-online-policy instruction may be an instruction requesting “please create an online policy” or an instruction indicating “the type of online policy desired to be created”.

In other words, the instruction indicating “the type of online policy to be created” is an instruction indicating “the type of access rights to be set for each user”.

Step S201 starts when the policy server 103 receives the create-online-policy instruction.

In step S201, the policy server 103 creates and stores an online policy for a specified document in accordance with the create-online-policy instruction. The online policy is a file showing what access rights are set for a user having a certain user ID. In other words, this is a file showing association of user information with access rights.

In step S202, the policy server 103 creates a document license that includes policy server identification information and policy identification information. The policy server identification information is information for identifying a policy server, such as an IP address.

The policy identification information is information for identifying an online policy stored in the policy server 103, such as an ID.

In step S203, the policy server 103 electronically signs (e-signs) the document license to assure data matching. In addition, the policy server 103 creates a document key (a type of encryption key) used later to encrypt the document. The document key, created for each document to which an online policy is applied, is a unique key for a specified document in the present embodiment.

In step S204, the policy server 103 encrypts the online policy created in step S201.

In step S205, the policy server 103 associates the document license, the document key, and the encrypted online policy with one another and sends them to the client computer 102.

Further, in step S205, the encrypted online policy, the policy ID, and the document key sent to the client computer 102, associated with one another, are stored in the policy server 103, although they have been sent out.

In step S301, the client computer 102 receives the associated document license, document key, and encrypted online policy from the policy server 103.

Then the control unit 1022 of the client computer 102, on which Acrobat available from Adobe is installed, applies the online policy to the above-described specified document.

This application process is described in steps S302 to S304.

In step S302, the control unit 1022 of the client computer 102 first encrypts the document using the received document key. After the encryption, the flow proceeds to step S303.

In step S303, the control unit 1022 of the client computer 102 determines that the document key is no longer needed after the encryption, and destroys the document key.

In step S304, the control unit 1022 of the client computer 102 embeds the document license and encrypted online policy in the encrypted document. This concludes the process of applying the online policy to the document.

### Access to a Document Used in an Online Environment

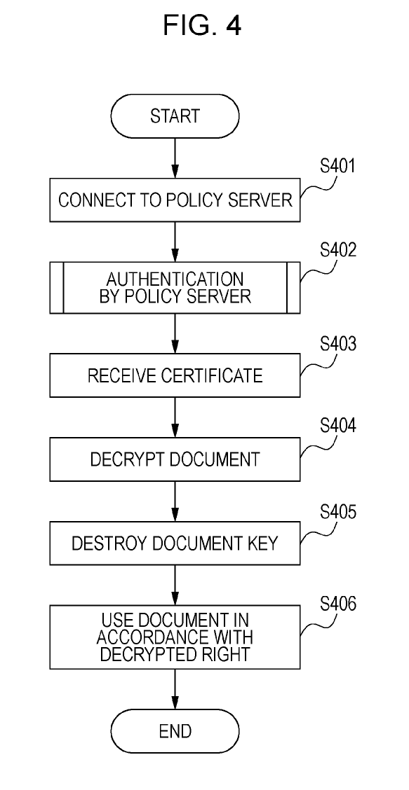

FIG. 4 shows a flowchart of a process for accessing a document, required to be used in an online environment, to which an online policy has been applied.

Note that, in the present embodiment, description will be made assuming that an apparatus (i.e., the subject of the process shown in FIG. 4) which accesses a document happens to be the same as an apparatus (i.e., the subject of the process shown in FIG. 3) which applied an online policy to the document. In other words, the subject of the process shown in FIG. 4 is assumed to be the client computer 102 in the description. However, the process described in FIG. 3 and the process described in FIG. 4 will not change at all even if the subject of the process shown in FIG. 3 is different from the subject of the process shown in FIG. 4.

When the control unit 1022 is instructed by a user to open a document to which an online policy has been applied, the following processing is performed.

In step S401, the control unit 1022 is connected to a policy server via the network 101 to access a document to which an online policy has been applied.

It is assumed that the control unit 1022 finds a policy server that stores the policy applied to the document and the policy, in accordance with a document license (including policy server identification information and policy identification information) embedded in the document. Note that the policy server identified by the policy server identification information is assumed to be the policy server 103, in the present example.

A policy identified by the policy identification information is the policy stored in the policy server 103 in association with the policy identification information, in step S205.

Further, the control unit 1022 of the client computer 102 is assumed to send the user ID and password received from a user to the policy server 103, while the above connection is established.

In step 402, the policy server 103 performs authentication for the ID sent from the control unit 1022 of the client computer 102.

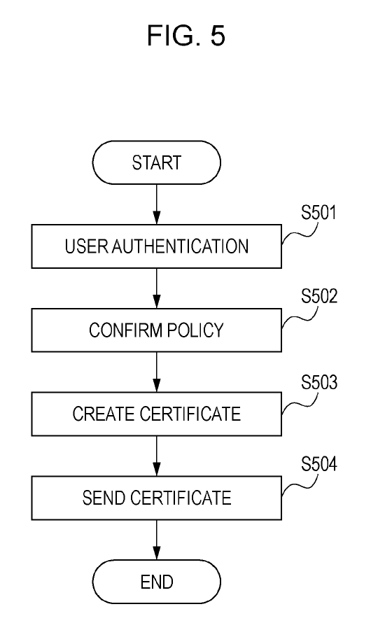

When the authentication is successful, the policy server 103 confirms the content of the policy identified by the policy identification information, and sends a certificate file (described later in FIG. 5) to the control unit 1022.

The details of the process performed in step S402 are shown in steps S501 to S504.

FIG. 5 is a flowchart showing the authentication process of the online policy performed by the policy server 103.

In step S501, the policy server 103 performs authentication (verifying an input password) for the user ID received from the client computer 102. Then the policy server 103 obtains user information, stored in the policy server 103, associated with the user ID.

In step S502, the policy server 103 compares the found online policy with the user information obtained in step S501, and determines the access rights (shown in the user information) of the user having the user ID for the document. Further, the policy server 103 reads out, from the storage, the document key (associated with the online policy) stored in step S205.

In step S503, the policy server 103 creates a certificate file that contains the document key and the access rights of the user identified by the user information.

In step S504, the policy server 103 sends the certificate file created in step S503 to the client computer 102.

In step S403, the control unit 1022 of the client computer 102 receives the certificate file sent from the policy server 103 and starts to access the document.

In step S404, the control unit 1022 decrypts the document corresponding to the certificate file using the document key contained in the certificate file. After the decryption, the flow proceeds to step S405.

In step S405, the control unit 1022 destroys the document key used for the decryption of the document, whose decryption has been completed.

In step S406, the control unit 1022 controls access to the document in accordance with the access rights contained in the certificate file. In other words, only the processing permitted by the access rights can be performed by the control unit 1022. The client computer 102 destroys the certificate file at the end of accessing the document.

Hereinafter, “a technology for editing documents having different rights”, a characteristic of the present embodiment, is described.

### Importing Documents

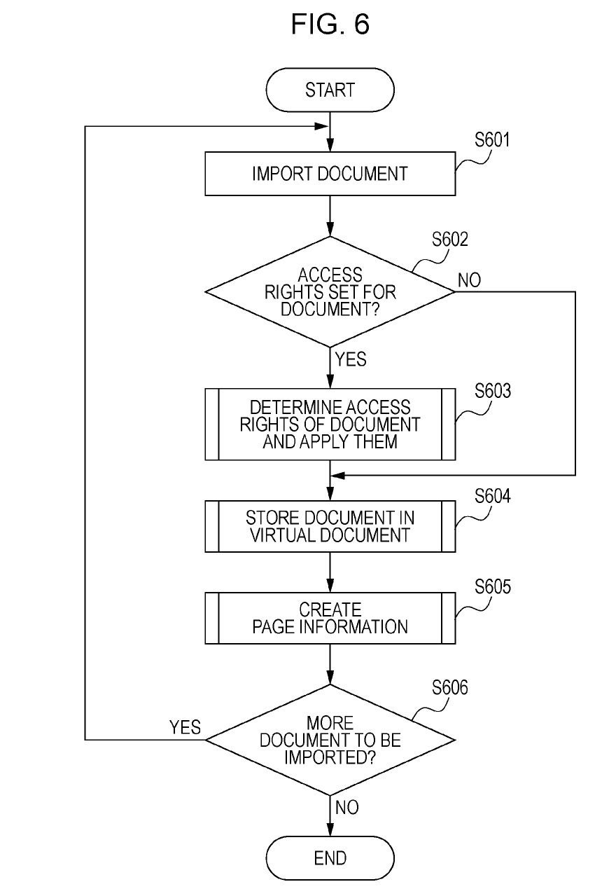

FIG. 6 is a flowchart showing the process of importing a plurality of selected documents. When the control unit 1022 is instructed by a user to import a plurality of documents, the following processing is performed.

In step S601, the control unit 1022 imports a document and the flow proceeds to step S602.

In step S602, the control unit 1022 determines whether or not access rights have been set for the document. When access rights have been set, the flow proceeds to step S603, and when not, the flow proceeds to step S604.

In step S603, the control unit 1022 determines the access rights of the document in accordance with the processing shown in FIGS. 2 to 5, and opens the document in accordance with the access rights.

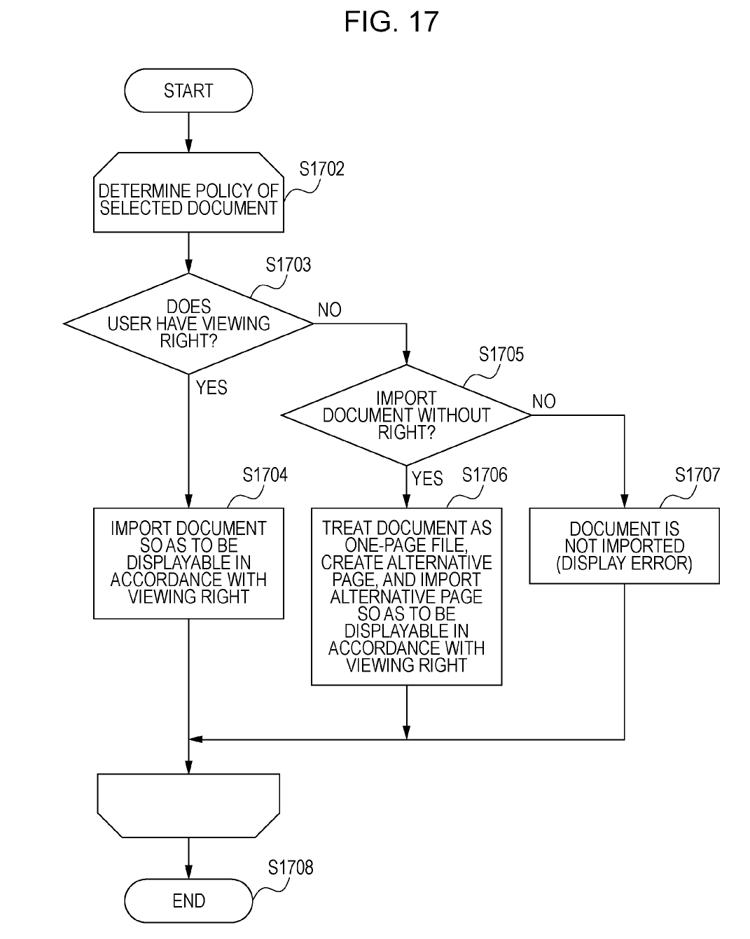

FIG. 17 shows the details of step S603.

In step S1702, the access rights for a selected document are determined. Then, in step S1703, it is determined whether or not the user performing processing has a viewing right for the selected document.

When it is determined that the user has a viewing right, the flow proceeds to step S1704, where the document, together with the viewing right of the user attached thereto, is imported into a virtual document.

When a page of the document is to be output (to be previewed, for example), it is output in accordance with the viewing right.

When it is determined that the user does not have a viewing right, the flow proceeds to step S1705.

When it is determined in step S1705 that the document is to be imported into the virtual document even without a viewing right, the flow proceeds to step S1706, where a page alternative to the page included in the selected document is created and imported into the virtual document.

When it is determined in step S1705 that the document is not to be imported, the selected document is not imported into the virtual document, and the situation is treated as an error (step S1707).

Here, the alternative page is a temporary page, such as a blank page, in which the content of the page included in the document is not reflected.

Further, in the case where the selected document is not imported into the virtual document, treated as an error, a user may be notified of a message saying “The selected document is not to be imported”, via a display screen, etc.

Then the flow proceeds to step S1708.

In step S604, the document that has been imported into the virtual document is stored. The details of step S604 will be described in steps S701 to S704.

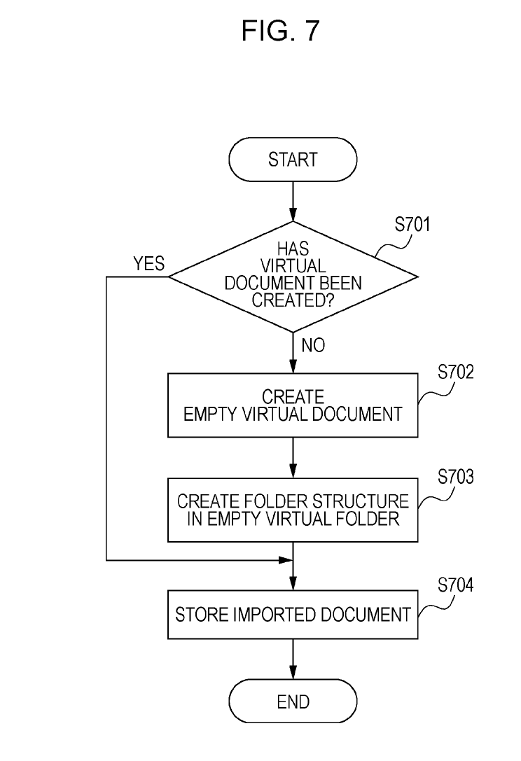

FIG. 7 is a flowchart showing the process of storing the imported documents in the virtual document, which is a file.

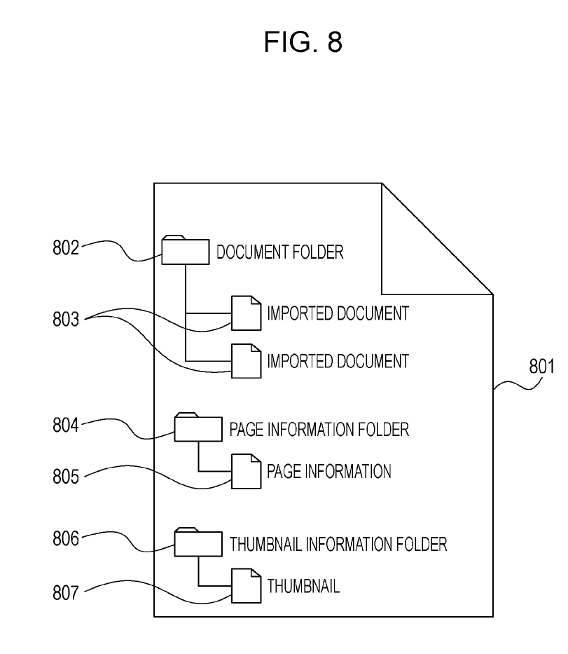

First, the virtual document will be explained. FIG. 8 shows a conceptual view of a virtual document.

A virtual document 801 is a ZIP file having a structure in which a plurality of documents are imported into one file.

The virtual document 801 includes a document folder 802, a page information folder 804, and a thumbnail information folder 806.

The document folder 802 stores imported documents 803 as they are.

The page information folder 804 stores a management file that manages page information 805 concerning the imported documents 803.

The thumbnail information folder 806 stores a thumbnail file 807 created for a preview.

In step S701, the control unit 1022 determines whether or not a virtual document has been created. When a virtual document has been created, the flow proceeds to step S704, and when not, the flow proceeds to step S702.

In step S702, the control unit 1022 creates an empty virtual document. In step S703, the control unit 1022 creates a folder structure in the empty virtual document.

FIG. 8 shows the structure of the virtual document created in step S703.

In step S704, the control unit 1022 stores the imported documents 803 in the document folder 802 in the virtual document 801.

In step S605, the control unit 1022 creates the page information 805 concerning the imported documents 803.

The details of the process performed in step S605 are described in steps S901 to S904.

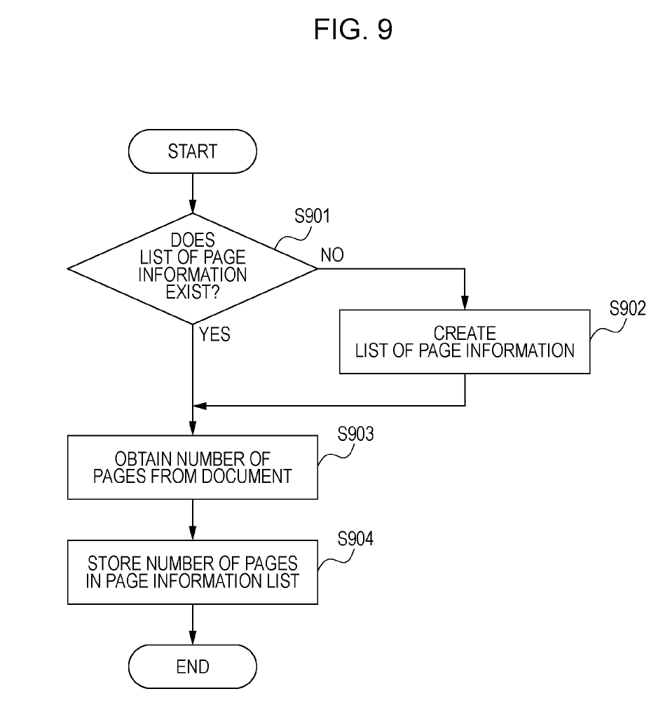

FIG. 9 is a flowchart showing the process of obtaining the page information 805 from the imported documents 803 and creating a page list described below.

In step S901, the control unit 1022 determines whether or not a list containing page information exists in the virtual document 801. When a page list exists, the flow proceeds to step S903, and when not, the flow proceeds to step S902.

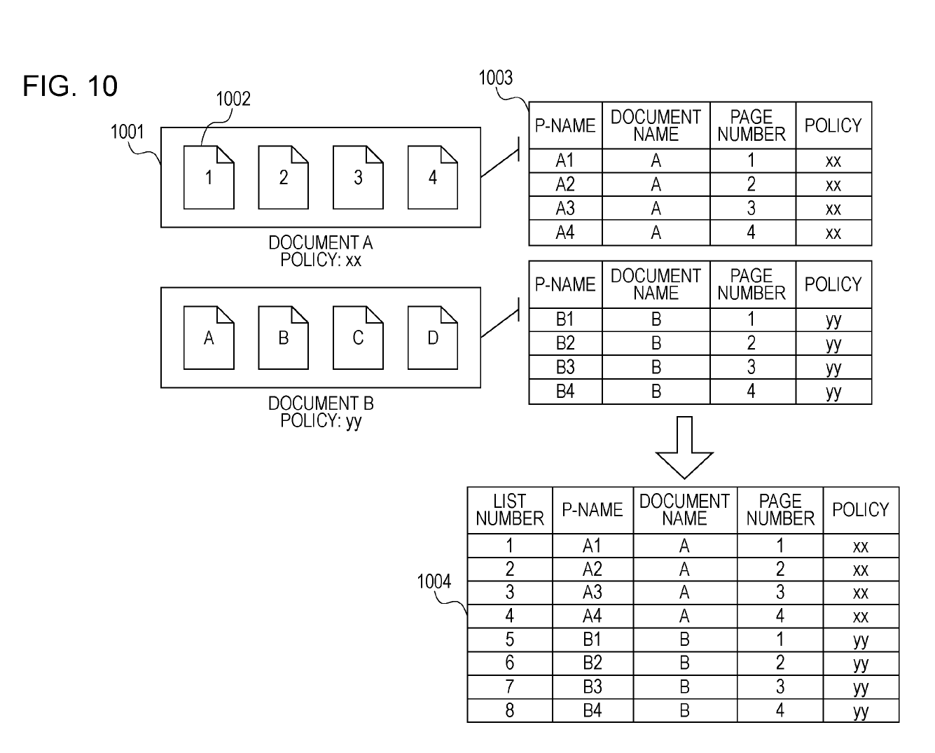

In step S902, the control unit 1022 creates a list for describing page information. This list is called a page list. FIG. 10 shows a structure of the page list created here. As shown in FIG. 10, the page list is arranged in a table, where each row corresponds to page information of each page. The plurality of imported documents are output on a display screen on the basis of this page list.

The page list arranged in a table may have a column for describing the access rights attached to a respective document to which each page belongs, as shown in FIG. 10.

This will make it easier to manage a page list since the policy of a document to which each page belongs becomes clear.

In step S903, the control unit 1022 obtains page information from an imported document.

In step S904, the control unit 1022 adds the page information to the page list to store it.

FIG. 10 is a conceptual view of a page list arranged in a table that describes page information. Reference numeral 1001 denotes a document to which access rights have been set. Reference numeral 1002 denotes a page in a document. Reference numeral 1003 denotes a list of page information (page list) created from the document 1001 to which access rights have been set. A unique number p-name is assigned to each page, and a document name, a page number, and a policy are stored for each page, thus forming a page list.

A document A includes pages 1 to 4, and is given an access right “xx”, which is policy identification information.

A document B includes pages A to D, and is given an access right “yy”, which is policy identification information.

Reference numeral 1004 denotes a page list made by combining the page information created in page lists 1003.

In step S606, the control unit 1022 determines whether or not there is another document to be imported, and when there is, the flow proceeds to step S601, and when not, the flow ends.

As described above, the documents imported into a virtual document by the control unit 1022 are referred to in accordance with the page information in a page list, and are output in the order in which they were referred to.

Note that outputting means displaying a preview and creating print data.

### Rearranging Pages of a Plurality of Documents

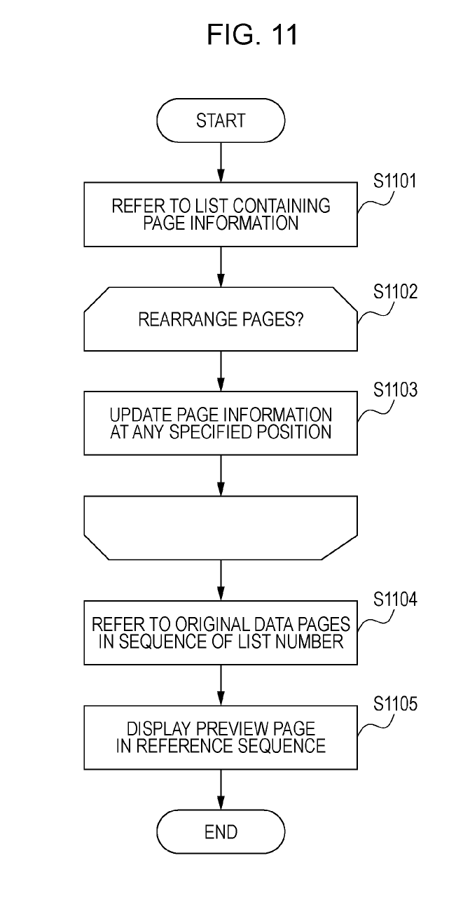

FIG. 11 is a flowchart showing the process of rearranging the pages of imported documents to change the order in which the pages are displayed.

In step S1101, the control unit 1022 refers to a page list that contains page information.

In step S1102, the control unit 1022 determines whether or not it has received an instruction to rearrange any specified pages, and when it has, the flow proceeds to step S1103, and when not, the flow proceeds to step S1104.

In step S1103, the control unit 1022 updates page information in accordance with the specified page setting.

In step S1104, the control unit 1022 refers to the pages of the original data in the sequence of the list number of the list that contains the created page information.

In step S1105, the control unit 1022 displays the original data to be previewed, in the sequence in which the pages were referred to in step S1104.

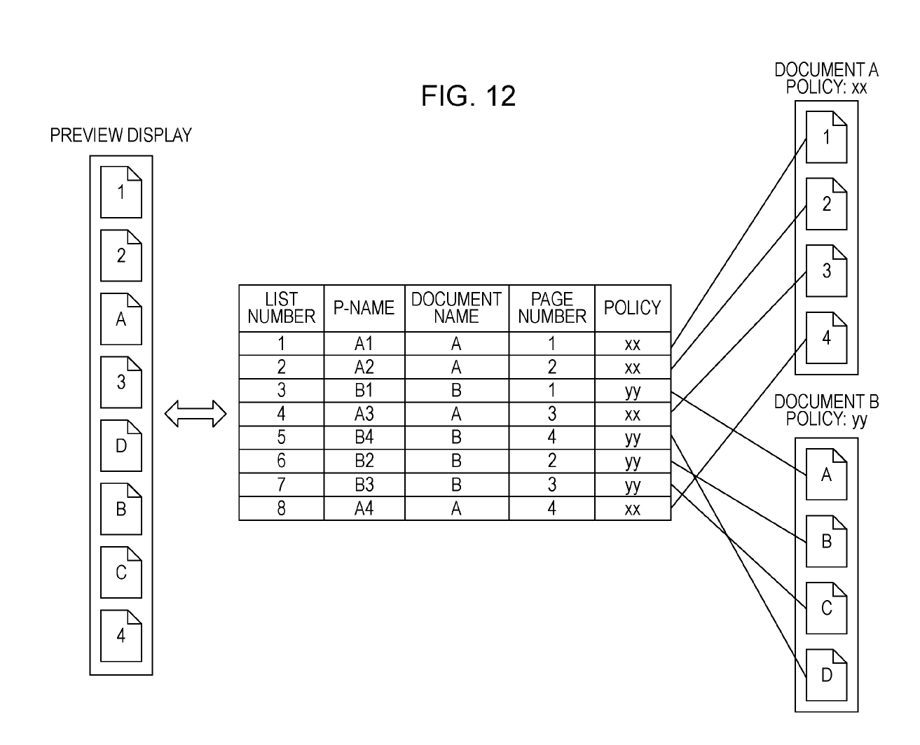

FIG. 12 shows a conceptual view of the state of a page list and displaying, during previewing.

Pages that have been included in different documents and given different policies are output in the sequence of the list number described in the page list.

Here, the sequence of the pages of the original documents is not changed, whereas the sequence in which the control unit 1022 refers to the pages in a virtual document changes.

### Copying and Deletion of Pages

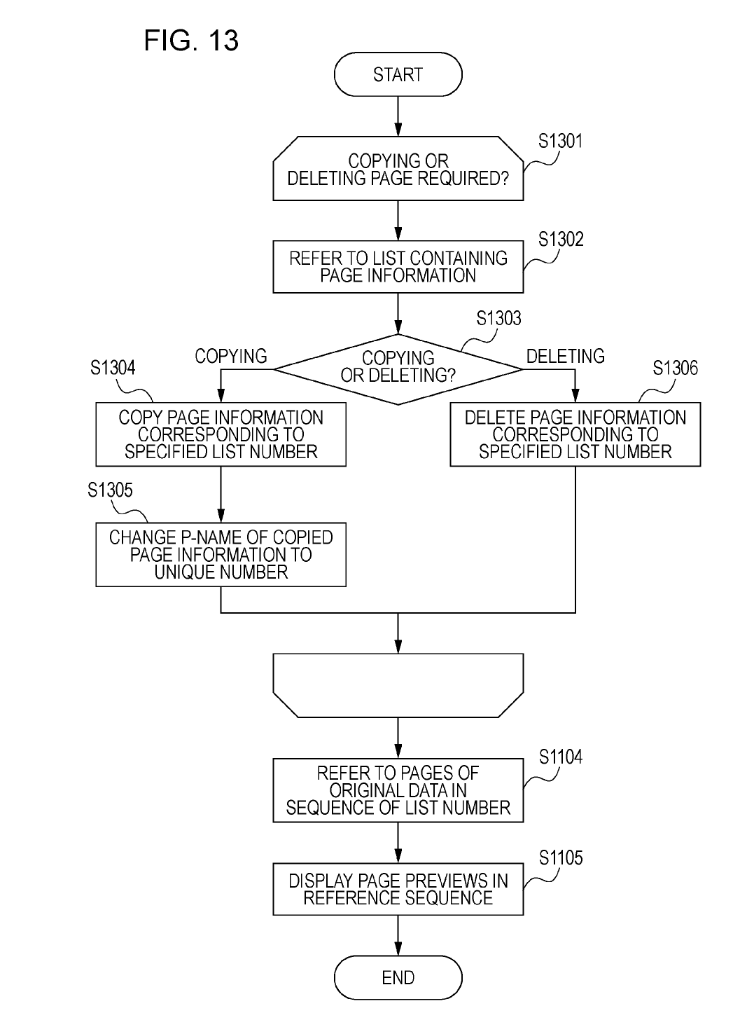

FIG. 13 is a flowchart showing the process of copying and deleting pages in a virtual document.

In step S1301, the control unit 1022 determines whether or not it has received an instruction to copy or delete pages, and when it has, the flow proceeds to step S1302, and when not, the flow proceeds to step S1104.

In step S1302, the control unit 1022 refers to a page list containing page information.

In step S1303, the control unit 1022 determines whether the received instruction specifies copying or deletion of pages. When copying is specified, the flow proceeds to step S1304, and when deletion is specified, the flow proceeds to step S1306.

In step S1304, the control unit 1022 copies the page information concerning the page corresponding to the specified list number and adds this information to the page list.

In step S1305, the control unit 1022 changes the value of the p-name of the copied page to a unique value.

In step S1306, the control unit 1022 deletes the page information of the specified list number of the page list, and updates the page list.

In steps S1304 to S1306, the original documents are not modified, and only the page list is updated.

The control unit 1022 refers to the pages in a virtual document on the basis of the updated page list.

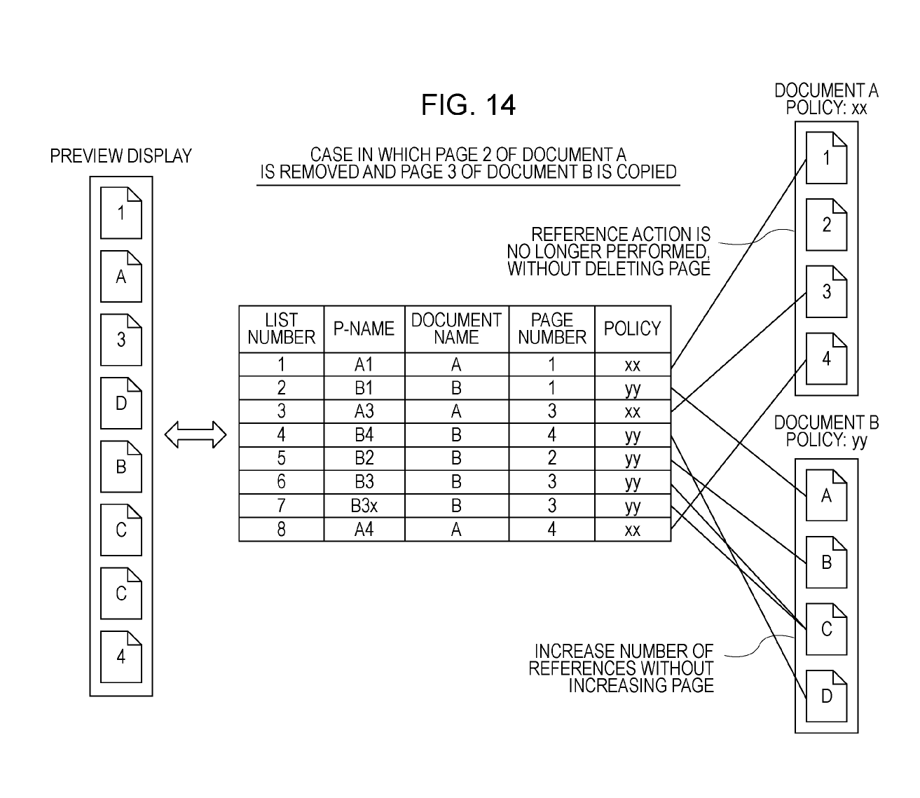

FIG. 14 shows a conceptual view of the state of a page list when pages are copied or deleted.

In a displayed preview, page 2 of the document A is deleted, and page C of the document B is copied. In this case, information such as access rights attached to page C of the original document B may be also attached to a new copied document B.

### Printing Data Including Rearranged Pages

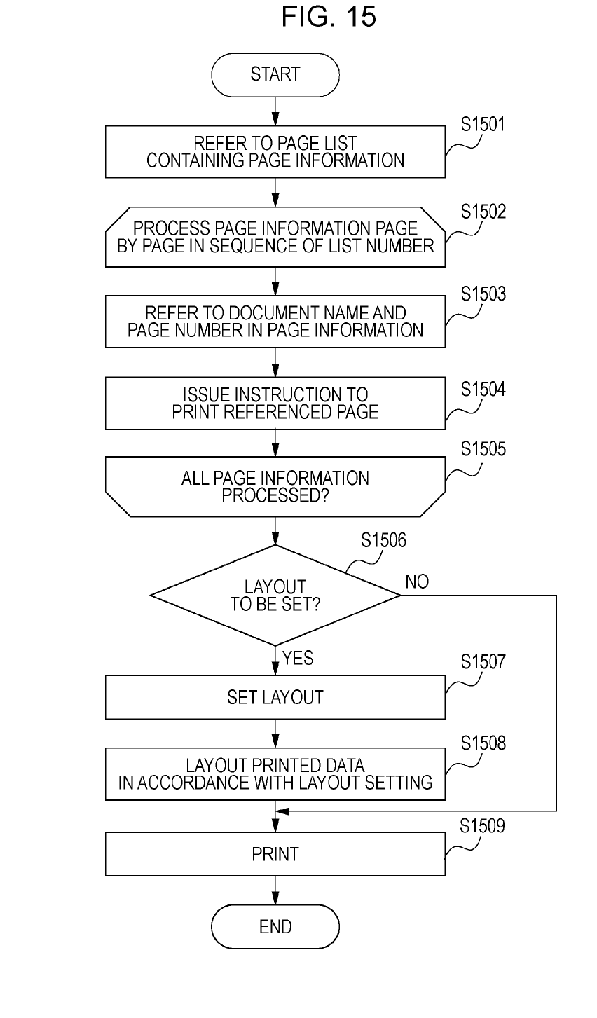

FIG. 15 is a flowchart showing the process of printing a document that has been created after being imported and edited as described above.

In step S1501, the control unit 1022 refers to a page list containing page information.

In step S1502, the control unit 1022 checks page information page by page in the order of the list number of the list.

In step S1503, the control unit 1022, by referring to the document name and page number in the page information, refers to the specified page in a virtual document.

In step S1504, the control unit 1022 issues an instruction to print the specified page.

In step S1505, the control unit 1022, determines whether or not there is another list number in the list that has not been processed, while referring to and processing the list in the order of the list number. When there is, the flow proceeds to step S1502, and when not, the flow proceeds to step S1506.

In other words, a printing process is performed in the order of the list number of the page list.

In step S1506, the control unit 1022 determines whether or not layout setting is to be performed on the printed data. When layout setting is to be performed, the flow proceeds to step S1507, and when not, the flow proceeds to step S1509, choosing the document size corresponding to the size of a sheet to be used.

In step S1507, the control unit 1022 performs layout setting by setting a sheet size and a layout of the document data corresponding to the sheet size.

In step S1508, the control unit 1022 modifies the printing data in order to perform scaling etc. in accordance with the layout setting performed in step S1507.

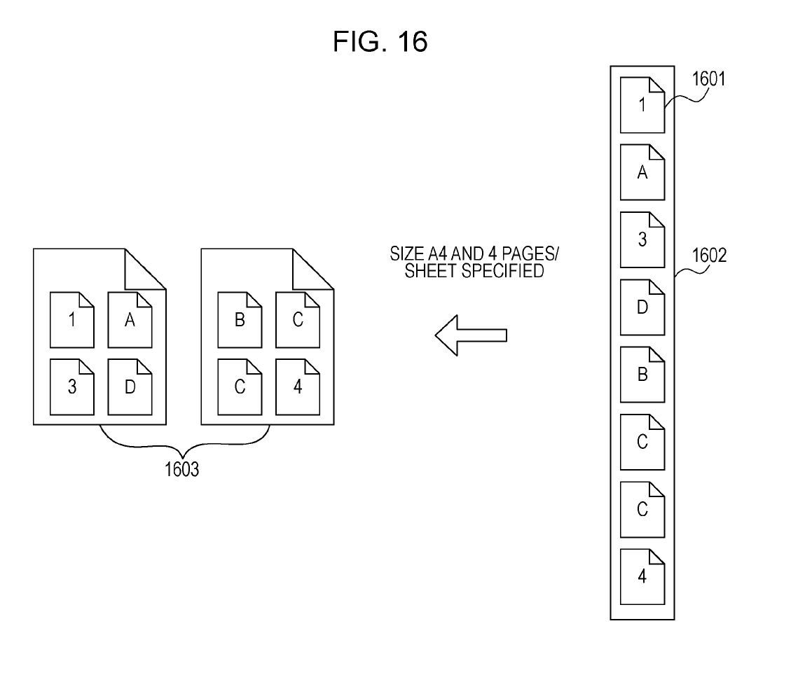

FIG. 16 shows an example layout change. Reference numeral 1601 denotes print data printed in step S1504. Data included in the print data is printed page by page, and the printed pages are stacked. Reference numeral 1602 denotes print data corresponding to all the to-be-printed pages of a document. Reference numeral 1603 shows the size of a sheet used for printing, set at the time of the layout setting. The size of a sheet is the sheet size set in step S1507.

In step S1509, the control unit 1022 requests the printer 104 to print the print data.

According to the embodiments described above, a plurality of documents can be merged without changing a policy, namely access rights, applied to each of the documents.

At this time, a layout can be set in an order specified by an instruction from a user, and a specified page of a document can be increased in number or deleted as required.

In addition, print data of a document merged in this way can be created in accordance with a layout setting.

Hence, this will increase user convenience.

### Other Embodiments

Furthermore, the embodiments described above include a method of processing in which the functions of the embodiments are realized by storing a program in a storage medium that causes the configuration of the embodiments to operate, and by making a computer read out and execute the program, as executable code, stored in the storage medium. The program itself and the storage medium that stores the program are included in the embodiments described above.

Examples of the storage medium include a floppy (registered trademark) disk, a hard disk, an optical disk, a magneto-optical disk, a CD-ROM, a magnetic tape, a non-volatile memory card, and a ROM.

In addition to the case in which the processing is performed only by the above-described program stored in the storage medium, the scope of the embodiments described above also includes the case in which the operations of the embodiments described above are executed under an OS by the program in collaboration with other software and with the functions of an expansion board.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-129581 filed May 16, 2008, which is hereby incorporated by reference herein in its entirety.

What is claimed is:

1. An information processing apparatus that manages a plurality of documents, each including a plurality of pages and being provided with an access right, the information processing apparatus comprising:
a storing unit configured to store the plurality of documents as one file on the basis of the access rights and information concerning a user who performs processing on the documents;
a creating unit configured to create a page list that describes page information, which is information regarding each page stored by the storing unit; and
an outputting unit configured to output a page imported into the file on the basis of the page list created by the creating unit.

2. The information processing apparatus according to claim 1,
wherein the storing unit, when the user does not have a viewing right for the document, either changes a page included in the document to an alternative page and imports the alternative page into the file or does not import the page, and
wherein the storing unit, when the user has the viewing right for the document, imports the page included in the document into the file without changing the page while keeping the viewing right attached to the page.

3. The information processing apparatus according to claim 1, wherein the page list is a list that describes page information, which is information regarding pages stored in the file by the storing unit, and describes at least the number of pages included in the document and the sequence in which the pages are output.

4. The information processing apparatus according to claim 1, further comprising:
a receiving unit configured to receive an instruction from a user,
wherein the information processing apparatus modifies the page information in the page list in accordance with the instruction from the user, and outputs a page imported into the file on the basis of the modified page list.

5. The information processing apparatus according to claim 4, wherein the instruction from the user is an instruction for copying or deleting a page in the file, or changing the sequence in which pages in the file are output when outputting is performed.

6. The information processing apparatus according to claim 4, wherein the instruction from the user is not reflected in original data even when the instruction from the user is received and, in the page list, a page is copied or deleted, or a sequence in which pages are output is changed.

7. A method of information processing in an information processing apparatus that manages a plurality of documents, each including a plurality of pages and being provided with an access right, the method of information processing comprising the steps of:
storing the plurality of documents as one file on the basis of the access rights and information of a user who performs processing on the documents;
creating a page list that describes page information, which is information regarding each page, stored in the storing step of storing; and
outputting a page imported in the file on the basis of the page list created in the creating step.

8. The method of information processing according to claim 7,
wherein, when the user does not have a viewing right for the document, the storing step includes either changing a page included in the document to an alternative page and importing the alternative page into the file or not importing the page, and
wherein, when the user has the viewing right for the document, the storing step includes importing the page included in the document into the file without changing the page while keeping the viewing right attached to the page.

9. The method of information processing according to claim 7, wherein the page list is a list that describes page information, which is information regarding pages stored in the file by the storing unit, and describes at least the number of pages included in the document and the sequence in which the pages are output.

10. The method of information processing according to claim 7, further comprising the step of:
receiving an instruction from a user,
wherein the page information of the page list is modified in accordance with the instruction from the user, and a page imported into the file is output on the basis of the modified page list.

11. The method of information processing according to claim 10, wherein the instruction from the user is an instruction for copying or deleting a page in the file, or changing the sequence in which pages in the file are output when outputting is performed.

12. The method of information processing according to claim 10, wherein the instruction from the user is not reflected in original data even when the instruction from the user is received and, in the page list, a page is copied or deleted, or a sequence in which pages are output is changed.

13. A program stored in a computer-readable storage medium for causing a computer to execute a method of information processing in an information processing apparatus that manages a plurality of documents, each including a plurality of pages and being provided with an access right, the method of information processing comprising the steps of:
storing the plurality of documents as one file on the basis of the access rights and information of a user who performs processing on the documents;
creating a page list that describes page information, which is information regarding each page stored in the storing step; and
outputting a page imported in the file on the basis of the page list created in the creating step.

14. A computer-readable storage medium that stores the program according to claim 13.
